(19) United States
(12) Patent Application Publication
(10) Pub. No.: US 2022/0410293 A1
(43) Pub. Date: Dec. 29, 2022

(54) RING REMOVAL APPARATUS

(71) Applicant: Philip James Belanger, Delta (CA)

(72) Inventor: Philip James Belanger, Delta (CA)

(21) Appl. No.: 17/304,690

(22) Filed: Jun. 24, 2021

(51) Int. Cl. B23D 29/02; B23D 15/04; B23D 35/00

(52) U.S. Cl. CPC B23D 29/02; B23D 15/04; B23D 35/005; B25F 5/005

(57) ABSTRACT

A ring removal apparatus configured to remove a ring from a finger utilizing a first technique or a second technique. The first technique employs cutting the ring while the second technique utilizes elements to distort the shape of the ring achieve removal. The ring removal apparatus includes a cutting assembly wherein the cutting assembly has a void centrally located therein and an opening thereto. The void has a first blade member and a second blade member on opposing sides thereof. The first blade member includes a ring protrusion member operably secured thereto and in axial alignment with the first blade member. The second blade member is movable in a forwards-backwards motion and is moved via a hydraulic assembly. The hydraulic assembly includes a conventional hydraulic cylinder that is operated via an operational lever so as to provide the movement of the second blade member.

### FIELD OF THE INVENTION

The present invention relates generally to jewelry removal apparatus, more specifically but not by way of limitation, a device that is designed to provide removal of a ring on a human finger wherein the present invention utilizes opposing cutting blades to sever the metal ring so as to facilitate subsequent removal from the finger.

### BACKGROUND

Jewelry has been worn for thousands of years. As is known in the art there are many types of jewelry to include but not limited to necklaces, earrings and rings. Regarding the latter, rings are worn by both men and woman and there are numerous types and styles of rings. Some common ring types are wedding rings and school class rings and these rings are often worn on the ring finger of either hand. Numerous other types of rings are also worn by users for cosmetic or other reasons. It is quite often that many types of rings are worn and never removed. This can be a common practice for rings such as but not limited to wedding rings. It can often be the case that these types of rings are worn for years without a wearer removing them from their finger.

One issue that develops after long term wearing of a ring is the inability to remove the ring from the finger. Various conditions and body changes can enlarge the size of the finger and it is common that a wearer will find that they are unable to remove the ring. Some common attempts to remove may include but are not limited to cold water and a surfactant but sometimes these are unsuccessful in the removal of the ring. Many times it becomes necessary for the ring to be removed with assistance of a mechanical device. Existing technology employs tools that either saw or grind the ring in order to facilitate the removal thereof. While these devices have proven effective, they are becoming increasingly less effective due to ring construction more commonly utilizing metals such as but not limited to titanium or steel. Current devices can take a significant amount of time to cut through these rings and this becomes a problem for the healthcare worker executing the task as well as present additional risks for the ring wearer.

Accordingly, there is a need for a ring removal apparatus that is configured to provide prompt removal of a ring wherein the apparatus is configured to facilitate the cutting of the ring in an efficient and prompt manner utilizing an assembly with opposing cutting blades.

### SUMMARY OF THE INVENTION

It is the object of the present invention to provide a ring removal apparatus configured to facilitate removal of a ring from a human finger wherein the ring removal apparatus includes a hydraulic assembly.

Another object of the present invention is to provide a ring removal device that is operable to cut a ring so as to remove from a human finger wherein the hydraulic assembly includes an operational lever.

A further object of the present invention is to provide a ring removal apparatus configured to facilitate removal of a ring from a human finger wherein the present invention includes a cutting assembly operably coupled to the hydraulic assembly.

Still another object of the present invention is to provide a ring removal device that is operable to cut a ring so as to remove from a human finger wherein the cutting assembly includes a ring receiving portion formed in the head of the cutting assembly.

An additional object of the present invention is to provide a ring removal apparatus configured to facilitate removal of a ring from a human finger wherein the ring receiving portion includes a void having a first blade and a second blade on opposing sides thereof.

Yet a further object of the present invention is to provide a ring removal device that is operable to cut a ring so as to remove from a human finger wherein the cutting assembly further includes a ring protruding member adjacent to the first blade and located underneath thereto.

Another object of the present invention is to provide a ring removal apparatus configured to facilitate removal of a ring from a human finger wherein the second cutting blade is movable via the hydraulic assembly in a backwards and forwards motion.

Still an additional object of the present invention is to provide a ring removal device that is operable to cut a ring so as to remove from a human finger wherein the cutting assembly is rotatable.

Still a further object of the present invention is to provide a ring removal apparatus configured to facilitate removal of a ring from a human finger wherein the first blade and second blade further include distortion cap members that can be utilized to misshape a portion of the ring an place of cutting.

Yet an additional object of the present invention is to a ring removal device that is operable to cut a ring so as to remove from a human finger wherein embodiments of the present invention can be manually operated or motorized.

Still another object of the present invention is to provide a ring removal apparatus configured to facilitate removal of a ring from a human finger wherein the ring protruding member is lower than that of the bottom edge of the first cutting blade.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is side view of the present invention; and

FIG. 2 is a perspective view of the present invention; and

FIG. 3 is an end view of a distortion cap member; and

FIG. 4 is an end view of a second embodiment of a distortion cap member.

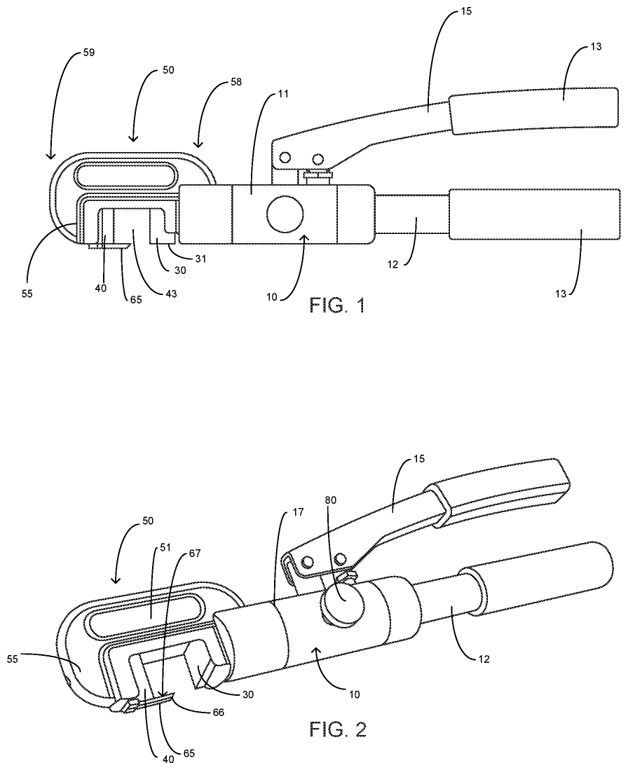

### DETAILED DESCRIPTION

Referring now to the drawings submitted herewith, wherein various elements depicted therein are not necessarily drawn to scale and wherein through the views and figures like elements are referenced with identical reference numerals, there is illustrated a ring removal apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the ring removal apparatus 100 includes a hydraulic assembly 10. The hydraulic assembly 10 includes a lower handle member 12 operably secured thereto and in axial alignment therewith. The hydraulic assembly 10 is a conventional hydraulic piston that is operably coupled to the second blade member 30 and is configured to provide movement thereof. The hydraulic assembly 10 is configured to move the second blade member 30 in a backwards-forwards motion in order to facilitate cutting of a ring as will be further discussed herein. It should be understood within the scope of the present invention that the hydraulic assembly 10 could employ alternate sizes and pressure ratings of hydraulic cylinders as needed in order to achieve the desired objective for the ring removal apparatus 100. Adjustment knob 80 provides control of the movement of the piston within the hydraulic assembly 10 wherein the adjustment knob 80 is operable to permit operational lever to move the second blade member 30 forward for cutting and also to facilitate the retraction of the second blade member 30 towards housing 11.

The hydraulic assembly 10 is operably coupled to the operational lever 15.

The operational lever 15 is mechanically fastened to the housing 11 of the hydraulic assembly 10 utilizing suitable durable fasteners. The operational lever 15 is pivotally secured to the housing 11 and is operable to move in an upwards-downwards motion wherein the movement thereof provides operation of the hydraulic cylinder disposed in the hydraulic assembly 10. Operational lever 15 and lower handle member 12 include grip members 13 that facilitate improved engagement therewith. It should be understood within the scope of the present invention that the grip members 13 could be manufactured from rubber or similar material. The operational lever 15 is configured so as to facilitate movement of the second blade member 30 towards the first blade member 40 during a downward movement of the operational lever 15. While an operational lever 15 and a hydraulic assembly 10 are illustrated and discussed herein, it should be understood within the scope of the present invention that the ring removal apparatus 100 could employ alternate techniques and/or elements to facilitate movement of the second blade member 30. By way of example but not limitation, the ring removal apparatus 100 could employ an electric motor to drive the second blade member 30 or the hydraulic assembly 10 could be powered by an electric motor. While not particularly illustrated herein, the ring removal apparatus 100 could be provided with a mount wherein the mount would provide secure positioning of the ring removal apparatus 100 on a table or other suitable support surface. Additionally, if provided with a mount, a mount could be utilized to position the ring removal apparatus 100 in a vertical manner.

The cutting assembly 50 is rotatably coupled to the housing 11 at joint 17 utilizing suitable durable elements. It is desirable within the preferred embodiment of the present invention that the cutting assembly 50 is rotatable so as to provide a user of the ring removal apparatus 100 an ability to manipulate the cutting assembly to a preferred angle to execute a ring cutting procedure as the ring will be removed from a human finger. While a rotatably mounted cutting assembly 50 is desired, it is contemplated within the scope of the present invention that the cutting assembly 50 could be fixedly secured to the housing 11. The cutting assembly 50 includes upper support member 51 located above void 43 that extends intermediate the first end 58 and second end 59 of the cutting assembly 50. The upper support member 51 is contiguously formed with forward support member 55. The forward support member 55 provides the necessary mounting structure for the first blade member 40.

The first blade member 40 is secured to the forward support member 55 utilizing suitable durable techniques. The first blade member 40 acts in conjunction with the second blade member 30 to sever a ring placed therebetween subsequent the hydraulic assembly 10 moving the second blade member 30 towards the first blade member 40. It should be understood within the scope of the present invention that the first blade member 40 and second blade member 30 could be manufactured in alternate sizes and from various materials in order to achieve the desired objective of cutting a ring. While no particular height is required for the second blade member 30 and first blade member 40, it is desired within a preferred embodiment of the present invention that the height of the first blade member 40 and second blade member 30 be ten to seventeen millimeters.

Secured underneath the first blade member 40 is the ring protrusion member 65. The ring protrusion member 65 is axially aligned with the first blade member 40 and is planar in manner having end 66 that is tapered in shape. The ring protrusion member 65 is configured to be placed such that the ring protrusion member 65 will be underneath the ring being severed and above the finger on which the ring is located. The intermediate placement of the ring protrusion member 65 with respect to the finger and ring provides protection of the finger during the cutting process. It should be understood within the scope of the present invention that the ring protrusion member 65 could be provided in alternate lengths and/or widths. It should be further noted within the scope of the present invention that the upper surface 67 of the ring protrusion member 65 is below the lower edge 31 of the second blade member 30 so as to provide the needed alignment for desired operation of the ring removal apparatus 100. Additionally, it is contemplated within the scope of the present invention that the first blade member 40 and ring protrusion member 65 are mounted so as to be adjustable in a vertical direction.

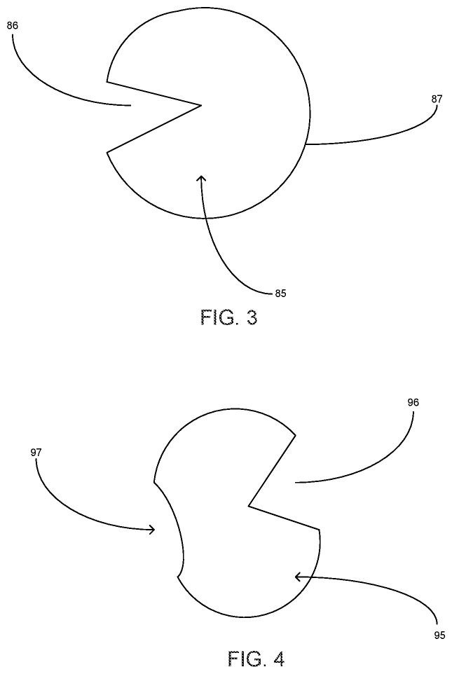

Now referring in particular to FIGS. 3 and 4, the ring removal apparatus 100 further includes distortion cap members 85,95. In some instances, as opposed to cutting a ring it may be desired to distort the shape so as to facilitate removal of the ring from a finger. The distortion cap members 85,95 are configured to be releasably secured to the first blade member 40 and second blade member 30 utilizing suitable techniques. The distortion cap member 85 is annular in shape having a mounting slit 86 that is designed to mateably fit over either the first blade member 40 or second blade member 30. Distortion cap member 95 includes mounting slit 96 similar to that of distortion cap member 85. However, distortion cap member 95 further includes a concave portion 97 on the leading edge thereof. The concave portion 97 is formed to receive a portion of a ring thereagainst and bias against the circumferential edge 87 of the distortion cap member 85 so as to provide distortion of the shape of the ring instead of cutting so as to facilitate removal of the ring from a finger. While a preferred embodiment of the distortion cap members 85, 95 have been illustrated herein, it is contemplated within the scope of the present invention that the distortion cap members 85,95 could be provided in alternate shapes and/or sizes in order to facilitate the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An apparatus configured to facilitate removal of a ring from a human finger wherein the apparatus comprises:
a cutting assembly, said cutting assembly having a body, said body of said cutting assembly having a first end and a second end, said cutting assembly having an upper portion and a lower portion, said cutting assembly having a void formed therein wherein said void is accessible via an opening proximate a lower edge of the cutting assembly, said cutting assembly having a first blade member and a second blade member, said first blade member and said second blade member being disposed on opposing sides of said void; and
a movement assembly, said movement assembly being operably coupled to said cutting assembly, said movement assembly configured to provide movement of said second blade member, said movement assembly operable to provide a forwards-backwards movement of said second blade member, said movement assembly in axial alignment with said cutting assembly.

2. The apparatus configured to facilitate removal of a ring from a human finger as recited in claim 1, wherein said movement assembly is either hydraulic or electric.

3. The apparatus configured to facilitate removal of a ring from a human finger as recited in claim 1, wherein said cutting assembly further includes a ring protrusion member, said ring protrusion member being in axial alignment with and underneath said first blade member.

4. The apparatus configured to facilitate removal of a ring from a human finger as recited in claim 3, wherein said ring protrusion member includes an end wherein said end of said ring protrusion member extends towards said void beyond a leading edge of said first blade member.

5. The apparatus configured to facilitate removal of a ring from a human finger as recited in claim 4, and further including a first distortion cap member, said first distortion cap member configured to be releasably secured to said first blade member.

6. The apparatus configured to facilitate removal of a ring from a human finger as recited in claim 5, and further including a second distortion cap member, said second distortion cap member configured to be releasably secured to said second blade member.

7. The apparatus configured to facilitate removal of a ring from a human finger as recited in claim 6, wherein said first distortion cap member and said second distortion cap member are configured to bias against the ring and facilitate distortion of a shape thereof.

8. An apparatus configured to facilitate removal of a ring from a human finger wherein the apparatus comprises:
a cutting assembly, said cutting assembly having a body, said body of said cutting assembly having a first end and a second end, said cutting assembly having an upper support member, said upper support member extending intermediate said first end and said second end proximate an upper portion of said body of said cutting assembly, said cutting assembly having a forward support member wherein said forward support member is integrally formed with said upper support member extending downward therefrom and being proximate said first end of said body, said cutting assembly having a void wherein said void is centrally located in said cutting assembly and accessible from an opening along a lower edge of said cutting assembly, said cutting assembly having a first blade member, said first blade member being secured to said forward support member and having a leading edge facing said void, said cutting assembly further having a second blade member, said second blade member being secured to said body opposite said void of said first blade member, said second blade member being movable towards said first blade member; and
a hydraulic assembly, said hydraulic assembly being integrally formed with said cutting assembly, said hydraulic assembly having a housing wherein said housing has a hydraulic cylinder disposed therein, said hydraulic assembly operably coupled to said second blade member, said hydraulic assembly configured to move said second blade member in a forwards-backwards motion, said hydraulic assembly further having a lower handle and an operational lever operably coupled thereto.

9. The apparatus configured to facilitate removal of a ring from a human finger as recited in claim 8, wherein said cutting assembly is rotatably coupled to said hydraulic assembly.

10. The apparatus configured to facilitate removal of a ring from a human finger as recited in claim 9, and further including a ring protrusion member, said ring protrusion member secured underneath said first blade member, said ring protrusion member being planar in manner, said ring protrusion member having an end extending inward towards said void.

11. The apparatus configured to facilitate removal of a ring from a human finger as recited in claim 10, wherein said end of said ring protrusion member further being tapered in shape and below a bottom edge of said second blade member.

12. The apparatus configured to facilitate removal of a ring from a human finger as recited in claim 11, wherein said first blade member is movable in an upwards downwards direction.

13. The apparatus configured to facilitate removal of a ring from a human finger as recited in claim 12, and further including a second distortion cap member, said second distortion cap member configured to be releasably secured to said second blade member.

14. The apparatus configured to facilitate removal of a ring from a human finger as recited in claim 13, and further including a first distortion cap member, said first distortion cap member configured to be releasably secured to said first blade member, said first distortion member having an annular shaped circumferential edge.

15. The apparatus configured to facilitate removal of a ring from a human finger as recited in claim 14, wherein said second distortion cap member further includes a concave portion, wherein said concave portion is configured to face said annular shaped circumferential edge of said first distortion cap member.

16. The apparatus configured to facilitate removal of a ring from a human finger as recited in claim 15, wherein said first distortion cap member and said second distortion cap member are configured to bias against the ring and facilitate distortion of a shape thereof.
